(19) United States
(12) Patent Application Publication
(10) Pub. No.: US 2025/0286749 A1
(43) Pub. Date: Sep. 11, 2025

(54) OPERATION DEVICE MANAGEMENT SYSTEM, OPERATION DEVICE MANAGEMENT APPARATUS, OPERATION DEVICE MANAGEMENT METHOD, AND RECORDING MEDIUM

(71) Applicant: Mitsubishi Electric Corporation, Tokyo (JP)

(72) Inventors: Yuji TAKEDA, Tokyo (JP); Naoki KIZU, Tokyo (JP); Shinya SUGINO, Tokyo (JP)

(21) Appl. No.: 18/859,713

(22) PCT Filed: Jun. 23, 2022
(86) PCT No.: PCT/JP2022/025190

§ 371 Date: Oct. 24, 2024

(51) Int. Cl. H04L 12/28

(52) U.S. Cl. CPC H04L 12/282; H04L 12/2809; H04L 12/281

(57) ABSTRACT

An operation device management server includes a control record storage to store, in a manner associated with one another, specific control information indicating specific control performed on a control target device through an operation performed previously on an operation device, operation device ID name information, and control target device ID name information, a search condition acquirer to acquire search condition information indicating a search condition for searching for at least one of control target device ID name information of a control target device, operation device ID name information of an operation device, or specific control information, a searcher to search for at least one of the control target device ID name information, the operation device ID name information, or the specific control information based on the search condition information, and a search result notifier to generate search result information to a terminal.

### CROSS-REFERENCE TO RELATED APPLICATION

This application is a U.S. national stage application of PCT/JP2022/025190 filed on Jun. 23, 2022, the contents of which are incorporated herein by reference.

### TECHNICAL FIELD

The present disclosure relates to an operation device management system, an operation device management apparatus, an operation device management method, and a non-transitory recording medium storing a program.

### BACKGROUND

An energy management system including a graphical user interface (GUI) apparatus and a device control apparatus that communicates with the GUI apparatus has been developed (see, for example, Patent Literature 1). The device control apparatus includes a collector that collects device information including device manufacturer information from a device connected to a network in a building, a display controller that causes the device name of the device to be displayed on the screen of a user interface device based on the device information collected from the device by the collector, and a registration processor that registers, with a storage, a device with the device name displayed on the screen when the device is selected as a management target.

### PATENT LITERATURE

Patent Literature 1: International Publication No. WO 2016/038882

For the energy management system described in Patent Literature 1, device control apparatuses have been developed for controlling an operation of a device based on a user operation on the GUI apparatus to control the device operation. Such a system may use an application to allow the GUI apparatus to function as an operation device for operating a device after the device is introduced into the market. An operation device for operating the device may also be introduced to the market subsequently with new functions reflecting the user convenience. A technique is thus awaited for the user to determine an optimum application or an optimum operation device for operating the device owned by the user.

### SUMMARY

Under such circumstances, an objective of the present disclosure is to provide an operation device management system, an operation device management apparatus, an operation device management method, and a program that allow a user to appropriately determine an optimum operation device for operating a control target device owned by the user or an optimum control target device to be controlled through an operation on an operation device owned by the user.

To achieve the above objective, an operation device management system according to an aspect of the present disclosure includes a terminal and a control device. The control device includes a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed, and first processing circuitry to acquire search condition information transmitted from the terminal and indicating a search condition for searching for at least one of control target device identification information of a control target device controllable with an operation device operated by a user, operation device identification information of an operation device to control a control target device when operated by a user, or specific control information indicating specific control having a record of being performed on the control target device, to search the control target device identification information, the operation device identification information, and the specific control information stored in the control record storage for at least one of the control target device identification information, the operation device identification information, or the specific control information based on the search condition information, and to generate, when at least one of the control target device identification information, the operation device identification information, or the specific control information is detected, search result information including at least one of the detected control target device identification information, the detected operation device identification information, or the detected specific control information, and transmit the search result information to the terminal. The control record storage further stores, in a manner associated with the control target device identification information, class information indicating a class of the at least one control target device classified based on a type of the at least one control target device. When searching for at least one of the operation device identification information or the control target device identification information based on the search condition and not detecting the operation device identification information or the control target device identification information, the first processing circuitry searches for at least one of operation device identification information of an operation device or control target device identification information of a control target device in a same class as at least one of the operation device being a search target or the control target device being a search target.

With the technique according to the above aspect of the present disclosure, the searcher searches for, based on the search condition information, at least one of control target device identification information of a control target device controllable with an operation device operated by a user, operation device identification information of an operation device to control a control target device when operated by a user, or specific control information indicating specific control having a record of being performed on the control target device. The search result notifier generates, when at least one of the control target device identification information, the operation device identification information, or the specific control information is detected, search result information including at least one of the detected control target device identification information, the detected operation device identification information, or the detected specific control information, and transmit the search result information to the terminal. With this technique, for the operation device or the control target device owned by the user, a control target device having a record of combined use with the operation device in previous operations performed on the control target device or an operation device having a record of combined use with the control target device in previous operations performed on the control target device can be presented to the user. Thus, the user can appropriately determine an optimum operation device for operating a control target device owned by the user or an optimum control target device to be controlled through an operation on an operation device owned by the user.

### BRIEF DESCRIPTION OF DRAWINGS

FIG. 1 is a schematic diagram of an operation device management system according to an embodiment of the present disclosure, illustrating an example configuration;

FIG. 2 is a block diagram of the operation device management system according to the embodiment, illustrating the hardware configuration;

FIG. 3 is a functional block diagram of the operation device management system according to the embodiment;

FIG. 4 is a diagram illustrating example information stored in a master information storage in an operation device management server according to the embodiment;

FIG. 5 is a diagram illustrating example information stored in a control record storage in the operation device management server according to the embodiment;

FIG. 6 is a sequence diagram describing the operation of the operation device management system according to the embodiment;

FIG. 7 is a diagram of an example operation screen image displayed on a display in a terminal in the embodiment;

FIG. 8A is a diagram of an example operation screen image displayed on the display in the terminal in the embodiment;

FIG. 8B is a diagram of another example operation screen image displayed on the display in the terminal in the embodiment;

FIG. 9A is a diagram of an example operation screen image displayed on the display in the terminal in the embodiment;

FIG. 9B is a diagram of another example operation screen image displayed on the display in the terminal in the embodiment;

FIG. 9C is a diagram of an example operation screen image displayed on the display in the terminal in the embodiment;

FIG. 10A is a diagram of another example operation screen image displayed on the display in the terminal in the embodiment;

FIG. 10B is a diagram of still another example operation screen image displayed on the display in the terminal in the embodiment;

FIG. 11 is a flowchart of an example device control process performed by a cloud server in the embodiment;

FIG. 12 is a flowchart of an example operation device management process performed by the operation device management server according to the embodiment;

FIG. 13 is a diagram of another example operation screen image displayed on a display in a terminal in a modification;

FIG. 14 is a functional block diagram of an operation device management system according to a modification;

FIG. 15 is a diagram illustrating example information stored in a control record storage in an operation device management server according to the modification; and

FIG. 16 is a flowchart of an example operation device management process performed by the operation device management server according to the modification.

### DETAILED DESCRIPTION

An operation device management system according to one or more embodiments of the present disclosure is now described with reference to the drawings. The operation device management system includes a terminal, a control record storage, a search condition acquirer, a searcher, and a search result notifier. The control record storage stores, in a manner associated with one another, specific control information indicating specific control performed on at least one control target device through an operation performed previously on an operation device, operation device identification (ID) information identifying the operation device that has been operated, and control target device ID information identifying at least one control target device on which the specific control has been performed. The search condition acquirer acquires search condition information transmitted from the terminal and indicating a search condition for searching for at least one of control target device ID information of a control target device controllable with an operation device operated by a user, operation device ID information of an operation device to control a control target device when operated by the user, or specific control information indicating specific control having a record of being performed on the control target device. The searcher searches for at least one of the control target device ID information, the operation device ID information, or the specific control information based on the search condition information from the control target device ID information, the operation device ID information, and the specific control information stored in the control record storage. The search result notifier generates, when at least one of the control target device ID information, the operation device ID information, or the specific control information is detected, search result information including at least one of the control target device identification information, the operation device identification information, or the specific control information that has been detected, and transmits the search result information to the terminal.

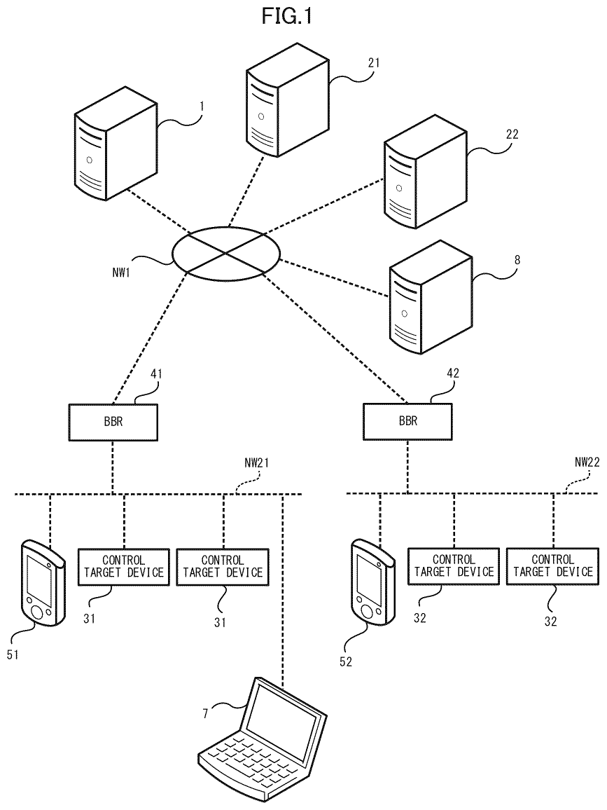

As illustrated in FIG. 1, an operation device management system according to the present embodiment includes a terminal 7 connected to one of multiple local area networks NW21 and NW22, and an operation device management server 1 that manages operation devices 51 and 52 connected to the respective local area networks NW21 and NW22. Multiple control target devices 31 and 32 to be controlled using the operation devices 51 and 52 have communication capabilities and are connected to the respective local area networks NW21 and NW22. The local area networks NW21 and NW22 are connected to a wide area network NW1 with respective broadband routers (hereafter referred to as BBRs) 41 and 42. Cloud servers 21 and 22 that control the control target devices 31 and 32 based on operations on the operation devices 51 and 52 by a user are connected to the wide area network NW1. A product list management server 8 is also connected to the wide area network NW1. The product list management server 8 manages websites showing lists of control target device ID names of the control target devices 31 and 32 and application ID names of operation device applications that are activated on the operation devices 51 and 52. Each of the local area networks NW21 and NW22 is, for example, a wired local area network (LAN) or a wireless LAN. The wide area network NW1 is, for example, the Internet.

Each of the control target devices 31 and 32 is, for example, a rice cooker, a ventilation fan, an air conditioner, a water heater, or a bathroom dehumidifier, and operates based on control information transmitted from the cloud server 21 or 22 for controlling the control target device 31 or 32. Each of the operation devices 51 and 52 is, for example, a smartphone and functions as an operation device for operating the corresponding control target device 31 or 32 with an application being activated for functioning as an operation device. Alternatively, each of the operation devices 51 and 52 is, for example, a remote controller dedicated to operating the corresponding control target device 31 or 32. Each of the operation devices 51 and 52 generates, when operated by the user, operation information indicating the specific operation and transmits the operation information to the corresponding cloud server 21 or 22.

The product list management server 8 manages a website showing a list of control target device ID names of the control target devices 31 and 32 recommended for the operating device applications activated on the operation devices 51 and 52 by manufacturers of the operating device applications, or a website showing a list of operation device ID names identifying the operation device applications recommended for the control target devices 31 and 32 by manufacturers of the control target devices 31 and 32. The product list management server 8 manages, for example, a website showing a whitelist being a list of operation device applications that guarantee normal operation in an environment in which the operations of the control target devices 31 and 32 are controlled through the cloud servers 21 and 22, and thus recommended for use by the manufacturers of the control target devices 31 and 32 or the manufacturers of the operation device applications that are activated on the operation devices 51 and 52. Examples of the whitelist include a list associating the operation device ID names identifying the operation device applications that are activated on the operation devices 51 and 52, and control target device ID names identifying the control target devices 31 and 32 controllable through an operation on the operation devices 51 and 52 with the operation device applications activated on the operation devices 51 and 52. When acquiring access request information requesting access to the above websites from the terminal 7, the product list management server 8 generates webpage information for allowing browse of the websites on the terminal 7 and transmits the webpage information to the terminal 7.

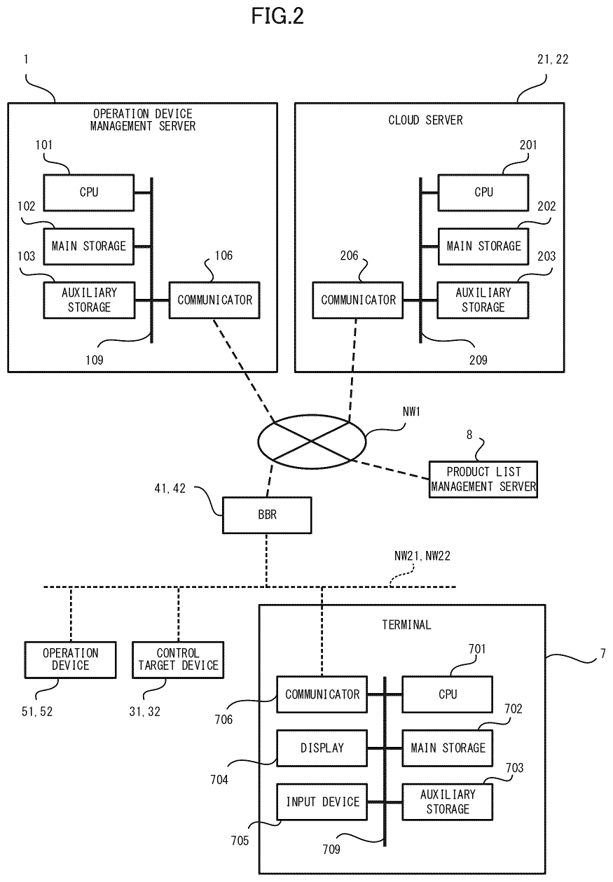

As illustrated in FIG. 2, the terminal 7 is, for example, a personal computer and includes a central processing unit (CPU) 701, a main storage 702, an auxiliary storage 703, a display 704, an input device 705, a communicator 706, and a bus 709 connecting the components to one another. The main storage 702 includes a volatile memory such as a random-access memory (RAM) and is used as a work area for the CPU 701. The main storage 702 also includes a memory for images (not illustrated) that temporarily stores image information to be displayed on the display 704. The auxiliary storage 703 is a nonvolatile memory such as a semiconductor flash memory and stores a program for the CPU 701 to perform various processes. The display 704 is a display device such as a liquid crystal display or an organic electroluminescent (EL) display. The input device 705 is, for example, a keyboard. The communicator 706 is connected to the local area networks NW21 and NW22 to transmit information transferred from the CPU 701 to the operation device management server 1 through the local area networks NW21 and NW22 and the wide area network NW1, and to transfer information received from the operation device management server 1 through the wide area network NW1 and the local area networks NW21 and NW22 to the CPU 701.

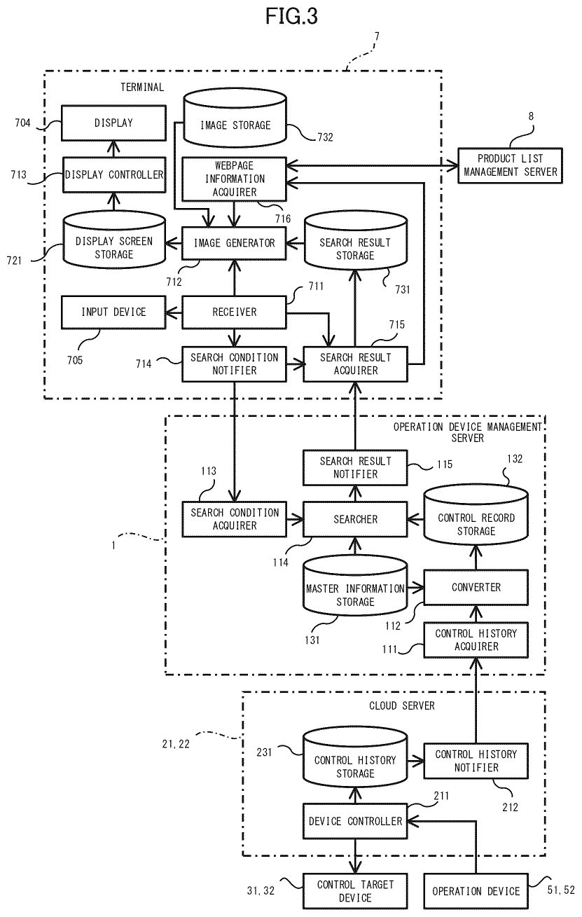

The CPU 701 loads the program stored in the auxiliary storage 703 into the main storage 702 and executes the program to function as a receiver 711, an image generator 712, a display controller 713, a search condition notifier 714, a search result acquirer 715, and a webpage information acquirer 716 as illustrated in FIG. 3. The auxiliary storage 703 illustrated in FIG. 2 includes a search result storage 731 and an image storage 732 as illustrated in FIG. 3. The memory for images in the main storage 702 illustrated in FIG. 2 includes a display screen storage 721 that temporarily stores screen images to be displayed on the display 704 as illustrated in FIG. 3. The search result storage 731 stores control target device ID information or operation device ID information included in search result information transmitted from the operation device management server 1. The control target device ID information identifies the control target device 32 (31) having a previous record of being controlled through an operation performed on the operation device 52 (51) of the same type as the operation device 51 (52) that is controlled by the user. The control target device ID information is input by the user with the input device 705. The operation device ID information identifies the operation device 52 (51) having a previous record of operating the control target device 32 (31) of the same type as the control target device 31 (32) that is to be operated by the user. The operation device ID information is input by the user with the input device 705. The image storage 732 stores various items of image information including the image information indicating basic icons for creating an operation screen image.

The receiver 711 receives a specific operation performed by the user on the input device 705, generates operation information corresponding to the received specific operation, and provides the operation information to the image generator 712, the search condition notifier 714, or the search result acquirer 715.

The image generator 712 generates a search screen image for the user to search for the control target device ID information of the control target devices 31 and 32 or the operation device ID information of the operation devices 51 and 52, or a search result notification screen image for notifying the user of a search result. The image generator 712 generates the search result notification screen image based on the various items of image information stored in the image storage 732 as well as the operation device ID information and the control target device ID information stored in the search result storage 731 in a manner associated with each other. The image generator 712 causes the display screen storage 721 to store the image information indicating the generated search screen image or the search result notification screen image. When the webpage information described below is provided from the webpage information acquirer 716, the image generator 712 generates a webpage image showing the lists of the control target device ID names and the operation device ID names based on the provided webpage information, and causes the display screen storage 721 to store the image information indicating the generated webpage image. The display controller 713 causes the display 704 to display the search screen image or the search result notification screen image described above based on the image information stored in the display screen storage 721.

With the display 704 displaying the search screen image, the search condition notifier 714 generates the search condition information indicating search conditions for searching for the control target device ID information or the operation device ID information based on information input by the user with the input device 705. More specifically, the search condition notifier 714 generates the search condition information including the operation device ID information of the operation device 51 or 52, or the control target device ID information of the control target device 31 or 32 input by the user. The search condition notifier 714 then transmits the generated search condition information to the operation device management server 1. The search condition notifier 714 also provides the operation device ID information or the control target device ID information input by the user to the search result acquirer 715.

When acquiring the search result information transmitted from the operation device management server 1, the search result acquirer 715 extracts the control target device ID information or the operation device ID information included in the acquired search result information, and causes the search result storage 731 to store the extracted control target device ID information or operation device ID information. When acquiring the search result information including the control target device ID information from the operation device management server 1, the search result acquirer 715 causes the search result storage 731 to store the control target device ID information extracted from the acquired search result information in a manner associated with the operation device ID information provided from the search condition notifier 714. When acquiring the search result information including the operation device ID information from the operation device management server 1, the search result acquirer 715 causes the search result storage 731 to store the operation device ID information extracted from the acquired search result information in a manner associated with the control target device ID information provided from the search condition notifier 714. When the search result information includes uniform resource locator (URL) information of a website managed by the product list management server 8, the search result acquirer 715 extracts the URL information from the search result information and provides the URL information to the webpage information acquirer 716.

When the URL information is provided from the search result acquirer 715, the webpage information acquirer 716 transmits the access request information described above to the product list management server 8 based on the provided URL information. The webpage information acquirer 716 then acquires the webpage information transmitted from the product list management server 8 and provides the acquired webpage information to the image generator 712.

As illustrated in FIG. 2, the cloud servers 21 and 22 each include a CPU 201, a main storage 202, an auxiliary storage 203, a communicator 206, and a bus 209 connecting the components to one another. The CPU 201 is, for example, a multicore processor. The main storage 202 includes a volatile memory such as a RAM and is used as a work area for the CPU 201. The auxiliary storage 203 is a large-capacity nonvolatile memory and stores a program for implementing various functions of the cloud server 21 or 22. The communicator 206 is connected to the wide area network NW1.

The CPU 201 loads the program stored in the auxiliary storage 203 into the main storage 202 and executes the program to function as a device controller 211 and a control history notifier 212 as illustrated in FIG. 3. The auxiliary storage 203 illustrated in FIG. 2 includes a control history storage 231 as illustrated in FIG. 3. The control history storage 231 stores specific control code information indicating specific control performed on the control target device 31 or 32 based on the operation information indicating a specific operation transmitted from the operation device 51 or 52 when the user performs an operation on the operation device 51 or 52. The control history storage 231 stores the specific control code information in a manner associated with operation device ID code information of the operation device 51 or 52, or operation device ID code information of the operation device application activated on the operation device 51 or 52, and with control target device ID code information of the control target device 31 or 32. The specific control code information is, for example, expressed in a first format using EPC parameters defined in the ECHONET Lite (registered trademark) standard. More specifically, for the specific control being power on-off setting, for example, the specific control information is set to 0x80. The operation device ID information is, for example, expressed in the first format using the operation device ID code assigned to the operation device application that is activated on the operation device 51 or 52. The control target device ID information is expressed in the first format using the control target device ID code assigned to the control target device 31 or 32.

When acquiring, from the operation device 51 or 52, specific operation information indicating a specific operation performed by the user on the operation device 51 or 52, the device controller 211 controls the control target device 31 or 32 based on the acquired specific operation information. The device controller 211 controls the operation of the control target device 31 or 32 by generating the control information for controlling the control target device 31 or 32 based on the specific operation information and transmitting the control information to the control target device 31 or 32. The control information includes the specific control code information described above. Each time the device controller 211 generates and transmits the control information to the control target device 31 or 32, the device controller 211 identifies the specific control code information included in the control information and causes the control history storage 231 to store the identified specific control code information in a manner associated with the operation device ID code information of the operation device 51 or 52 that is the source of the specific operation information and the control target device ID code information of the control target device 31 or 32 that is the destination of the control information.

The control history notifier 212 generates control history information including the specific control code information, the operation device ID code information, or the operation device ID code information and the control target device ID code information stored in the control history storage 231, and transmits the generated control history information to the operation device management server 1. The control history notifier 212 generates and transmits the control history information to the operation device management server 1 each time the control history storage 231 newly stores the specific control code information, the operation device ID code information, or the operation device ID code information and the control target device ID code information in a manner associated with one another. Alternatively, for example, the control history notifier 212 may generate, at each predetermined control history notification time, the control history information including the specific control code information, the operation device ID code information, or the operation device ID code information and the control target device ID code information newly stored in the control history storage 231 during a period from the immediately preceding control history notification time and the present control history notification time, and transmit the control history information to the operation device management server 1.

As illustrated in FIG. 2, the operation device management server 1 includes a CPU 101, a main storage 102, an auxiliary storage 103, a communicator 106, and a bus 109 connecting the components to one another. The CPU 101 is, for example, a multicore processor. The main storage 102 includes a volatile memory such as a RAM and is used as a work area for the CPU 101. The auxiliary storage 103 is a large-capacity nonvolatile memory and stores a program for implementing various functions of the operation device management server 1. The communicator 106 is connected to the wide area network NW1.

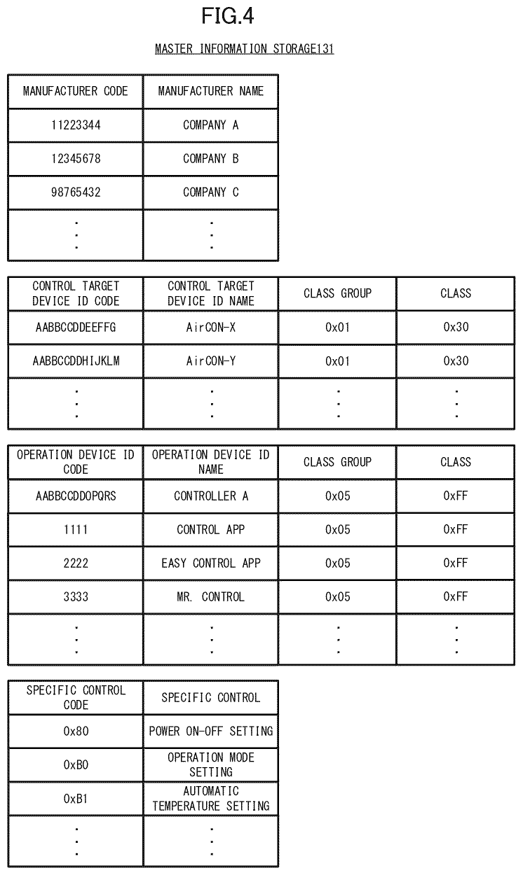

The CPU 101 loads the program stored in the auxiliary storage 103 into the main storage 102 and executes the program to function as a control history acquirer 111, a converter 112, a search condition acquirer 113, a searcher 114, and a search result notifier 115 as illustrated in FIG. 3. The auxiliary storage 103 illustrated in FIG. 2 includes a master information storage 131 and a control record storage 132 as illustrated in FIG. 3. The master information storage 131 stores information indicating the correspondence between the sets of information in the first format described above and sets of information in a second format different from the first format. As illustrated in FIG. 4, for example, the master information storage 131 stores manufacturer name information indicating the name of the manufacturer of the control target device 31 or 32 or the name of the manufacturer of the operation device application activated on the operation device 51 or 52 in a manner associated with manufacturer code information indicating a manufacturer code preassigned to the manufacturer. The master information storage 131 stores control target device ID name information identifying the control target device 31 or 32 in the second format in a manner associated with the control target device ID code information indicating the control target device ID code in the first format assigned to the control target device 31 or 32. The master information storage 131 stores the control target device ID name information and the control target device ID code information in a manner associated with class code information indicating a class of the control target device 31 or 32 as classified based on the type and class group code information. The master information storage 131 stores, in a manner associated with the operation device ID code information indicating the operation device ID code in the first format assigned to the operation device 51 or 52 or the operation device application, operation device ID name information indicating the operation device ID name identifying, in the second format, the above operation device 51 or 52, or the operation device application that is activated on the operation device 51 or 52. The master information storage 131 stores the operation device ID name information and the operation device ID code information in a manner associated with the class code information indicating the class of the operation device as classified based on the type and the class group code information. The master information storage 131 also stores the specific control information indicating the specific control performed on the control target device 31 or 32 in a manner associated with the specific control code information assigned to different types of specific control.

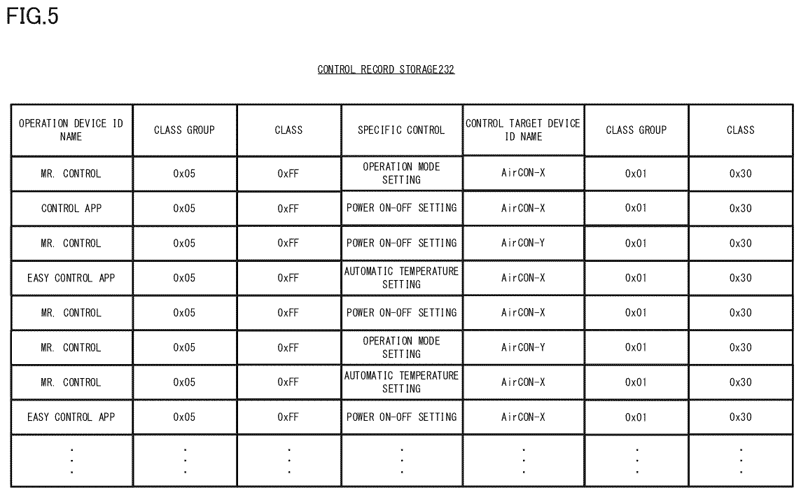

Referring back to FIG. 3, the control record storage 132 stores, in a manner associated with one another, the specific control information indicating the specific control performed on the corresponding control target device 31 or 32 through an operation performed previously on the operation device 51 or 52 by the user, the operation device ID name information identifying the operation device 51 or 52 that has been operated by the user, and the control target device ID name information identifying the corresponding control target device 31 or 32. As illustrated in FIG. 5, for example, the control record storage 132 stores the specific control information indicating the specific control performed on the control target device 31 or 32 through an operation performed previously on the operation device 51 or 52, together with the operation device ID name information of the corresponding operation device 51 or 52 and the control target device ID name information of the control target device 31 or 32 in a manner associated with the class code information and the class group code information of the operation device 51 or 52 and the control target device 31 or 32. Although not illustrated in FIG. 5, the control record storage 132 also stores the manufacturer name information indicating the manufacturer name of the operation device 51 or 52 and of the control target device 31 or 32 in a manner associated with the corresponding operation device ID name information and the control target device ID name information.

Referring back to FIG. 3, the control history acquirer 111 acquires control history information including the specific control code information indicating the specific control performed on the control target device 31 or 32, the operation device ID code information identifying the operation device 51 or 52 operated by the user, and the control target device ID code information identifying the control target device 31 or 32. The control history acquirer 111 extracts the specific control code information, the operation device ID code information, and the control target device ID code information included in the acquired control history information and provides the extracted sets of information to the converter 112.

The converter 112 converts the specific control code information, the operation device ID code information, and the control target device ID code information provided from the control history acquirer 111 respectively to the specific control information, the operation device ID name information, and the control target device ID name information, and causes the control record storage 132 to store the resultant sets of information. The converter 112 identifies, among the specific control information, the operation device ID name information, and the control target device ID name information stored in the master information storage 131, the specific control information, the operation device ID name information, and the control device ID name information associated with the specific control code information, the operation device ID code information, and the control target device ID code information provided from the control history acquirer 111. The converter 112 then causes the control record storage 132 to store the identified specific control information, the operation device ID name information, and the control target device ID name information. The converter 112 also refers to the manufacturer name information stored in the master information storage 131 to identify the manufacturer name information associated with the manufacturer code information provided from the control history acquirer 111, and causes the control record storage 132 to store the identified manufacturer name information in a manner associated with the operation device ID name information or the control target device ID name information.

The search condition acquirer 113 acquires the search condition information transmitted from the terminal 7 indicating the search conditions for searching for the control target device ID name information of the control target device 31 or 32 that is controllable by the operation device 51 or 52 operated by the user. Alternatively, the search condition acquirer 113 acquires the search condition information indicating the search conditions for searching for the operation device ID name information of the operation device 51 or 52 that can control the control target device 31 or 32 when operated by the user. The search condition acquirer 113 then provides the acquired search condition information to the searcher 114.

The searcher 114 searches for, based on the search condition information provided from the search condition acquirer 113, at least one of the control target device ID name information of the control target device 32 (31) having a record of being controlled through an operation performed on the operation device 52 (51) of the same type as the operation device 51 (52) that is specified in the search condition information, or the specific control information indicating the specific control in the record. Alternatively, the searcher 114 searches for at least one of the operation device ID name information of the operation device 52 (51) having a record of being operated to control the control target device 32 (31) of the same type as the control target device 31 (32) that is specified in the search condition information, or the specific operation information indicating the specific operation in the record. Alternatively, the searcher 114 searches for the specific control information indicating the specific control performed with the operation device 52 (51) of the same type as the operation device 51 (52) specified in the above search condition information on the control target device 32 (31) of the same type as the control target device 31 (32) specified in the above search condition information. In other words, when the search condition information includes the operation device ID name information and the control target device ID name information to be used as search keys, the searcher 114 searches for the specific control information using the operation device ID name information and the control target device ID name information as search keys. When the search condition information simply includes the control target device ID name information to be used as a search key, the searcher 114 searches for the operation device ID name information and the specific control information using the control target device ID name information as a search key. When the search condition information includes the control target device ID name information and the specific control information to be used as search keys, the searcher 114 searches for the operation device ID name information using the control target device ID name information and the specific control information as search keys. When the search condition information simply includes the operation device ID name information to be used as a search key, the searcher 114 searches for the control target device ID name information and the specific control information using the operation device ID name information as a search key. When the search condition information includes the operation device ID name information and the specific control information to be used as search keys, the searcher 114 searches for the control target device ID name information using the operation device ID name information and the specific control information as search keys.

When searching for the control target device ID name information of the control target device 32 (31) having a record of being controlled through an operation performed on the operation device 52 (51) of the same type as the operation device 51 (52) that is operated by the user and detecting no control target device ID name information, the searcher 114 searches for the control target device ID name information of the control target device 32 (31) with the same class code information assigned as the class code information of the control target device 32 (31). When further searching for the control target device ID name information of the control target device 32 (31) with the same class code information assigned as the class code information of the control target device 32 (31) and detecting no control target device ID name information, the searcher 114 searches for the control target device ID name information of the control target device 32 (31) with the same class group code information assigned as the class group code information of the control target device 32 (31). When detecting at least one of the control target device ID name information, the operation device ID name information, or the specific control information through the search, the searcher 114 provides at least one of the control target device ID name information, the operation device ID name information, or the specific control information that has been detected to the search result notifier 115.

When at least one of the control target device ID name information, the operation device ID name information, or the specific control information is provided from the searcher 114, the search result notifier 115 generates the search result information including the provided control target device ID name information or the operation device ID name information and transmits the search result information to the terminal 7. When the control target device ID name information or the operation device ID name information is not detected by the searcher 114, the search result notifier 115 generates the search result information including the URL information indicating the URL of a website managed by the product list management server 8 and transmits the search result information to the terminal 7. The URL information indicates, for example, the URL of a website showing a list of control target device ID names of the control target device 31 or 32 recommended for the operation device 51 or 52 by the manufacturer of the operation device 51 or 52, or the URL of a website showing a list of operation device ID names recommended for operating the control target device 31 or 32 by the manufacturer of the control target device 31 or 32.

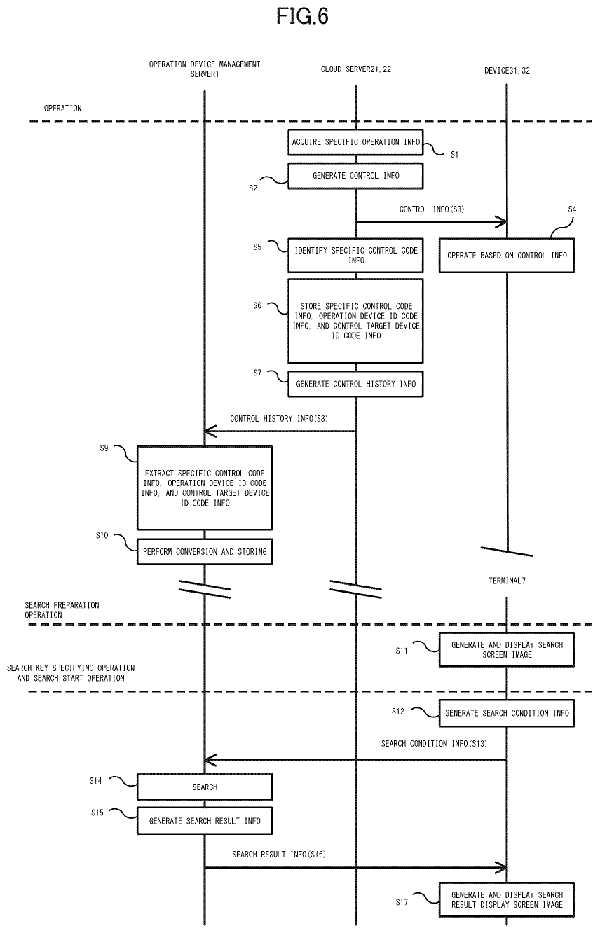

The operation of the operation device management system according to the present embodiment is now described with reference to FIGS. 6 to 10B. As illustrated in FIG. 6, when the user first performs an operation to control the operation of the control target device 31 or 32 on the operation device 51 or 52, the cloud server 21 or 22 acquires the operation information transmitted from the operation device 51 or 52 (step S1). The cloud server 21 or 22 generates the control information for controlling the control target device 31 or 32 based on the acquired specific operation information (step S2). The generated control information is transmitted from the cloud server 21 or 22 to the control target device 31 or 32 (step S3). When acquiring the control information, the control target device 31 or 32 starts operating based on the acquired control information (step S4). The cloud server 21 or 22 identifies the specific control code information indicating the specific control performed on the control target device 31 or 32 (step S5). The cloud server 21 or 22 then causes the control history storage 231 to store the generated specific control information in a manner associated with the operation device ID code information of the operation device 51 or 52 that is the source of the specific operation information or the operation device application activated on the operation device 51 or 52, and with the control target device ID code information of the control target device 31 or 32 that is the destination of the control information (Step S6). The cloud server 21 or 22 then generates the control history information including the specific control code information, the operation device ID code information, and the control target device ID code information stored in the control history storage 231 (step S7). The generated control history information is transmitted from the cloud server 21 or 22 to the operation device management server 1 (step S8).

When acquiring the control history information, the operation device management server 1 extracts the specific control code information, the operation device ID code information, and the control target device ID code information included in the acquired control history information (step S9). The operation device management server 1 then refers to the information stored in the master information storage 131 to convert the extracted specific control code information, operation device ID code information, and control target device ID code information respectively to the specific control information, the operation device ID name information, and the control target device ID name information, and causes the control record storage 132 to store the resultant sets of information (step S10).

In an example, the user also performs a search preparation operation on the input device 705 in the terminal 7 to search for the control target device ID name information of the control target device 31 or 32, or the operation device ID name information of the operation device 51 or 52. In this case, the terminal 7 generates the search screen image for the user to input the search conditions and causes the display 704 to display the search screen image (step S11).

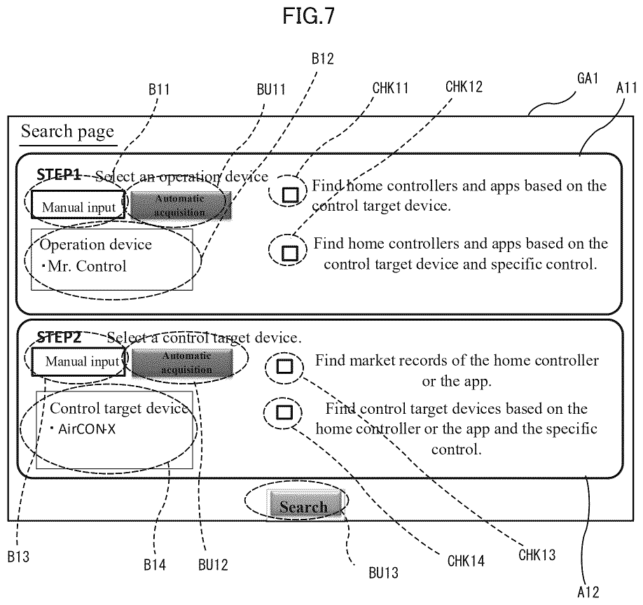

The terminal 7 causes the display 704 to display, for example, a search screen image GA1 illustrated in FIG. 7. The search screen image GA1 includes an area A11, an area A12, and a button image BU13. The search screen image GA1 specifies the operation device ID name information used as a key in searching for the specific control performed on the control target device 31 or 32, or the control target device ID name information of the control target device 31 or 32. The area A12 specifies the control target device ID name information used as a key in searching for the specific control performed on the control target device 31 or 32, or the operation device ID name information of the operation device 51 or 52. The button image BU13 displays Search to be selected to perform a search. The area A11 includes a display field B12 for displaying the operation device ID name used as a search key, an input field B11 for inputting the operation device name used as a search key, and a button image BU11 to be selected to automatically acquire the operation device ID name of the operation device 51 or 52 connected to the local area network NW21 or NW22 to which the terminal 7 is connected. The area A12 includes a display field B14 for displaying the control target device name used as a search key, an input field B13 for inputting the control target device ID name used as a search key, and a button image BU12 to be selected to automatically acquire the control target device name of the control target device 31 or 32 connected to the local area network NW21 or NW22 to which the terminal 7 is connected.

The area A11 further includes checkbox images CHK11 and CHK12 to be selected in searching without using the operation device name as a search key. When the checkbox image CHK11 is selected, the operation device ID name and the specific control are searched for using the control target device ID name as a search key. When the checkbox image CHK12 is selected, the operation device ID name is searched for using the control target device ID name and the specific control as search keys. The area A12 also includes checkbox images CHK13 and CHK14 to be selected in searching without using the control target device name as a search key. When the checkbox image CHK13 is selected, the control target device ID name and the specific control are searched for using the operation device ID name as a search key. When the checkbox image CHK14 is selected, the control target device ID name is searched for using the operation device ID name and the specific control as search keys.

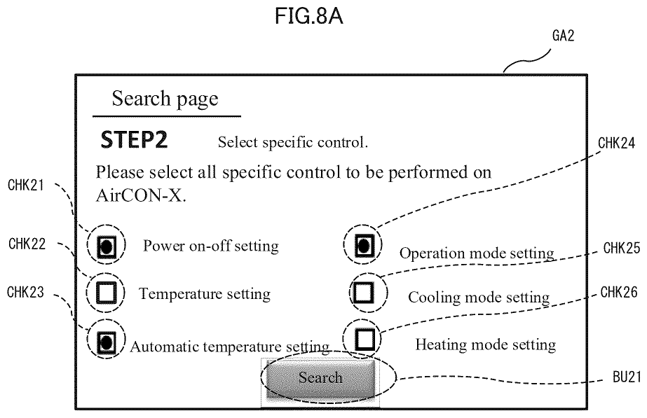

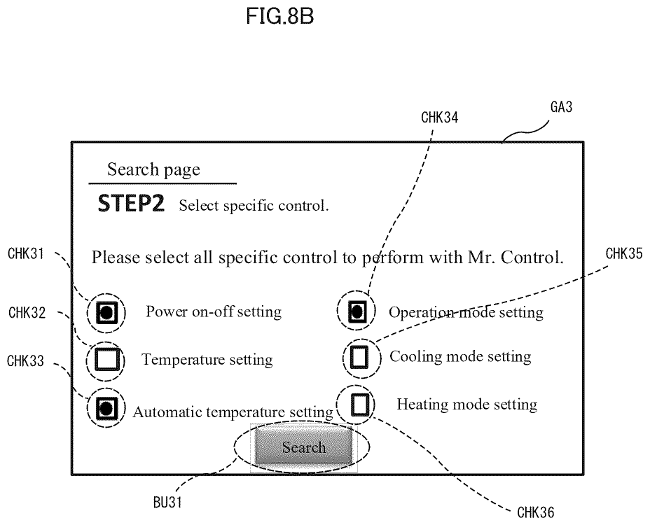

When the user selects the checkbox image CHK12 and then the button image BU13 with the input device 705, with the search screen image GA1 displayed on the display 704, a search screen image GA2 illustrated in FIG. 8A is displayed on the display 704. The search screen image GA2 includes checkbox images CHK21, CHK22, CHK23, CHK24, CHK25, and CHK26, and a button image BU21 displaying Search to be selected to perform a search. The checkbox images CHK21, CHK22, CHK23, CHK24, CHK25, and CHK26 are used as search keys together with the control target device name to respectively select the power on-off setting, temperature setting, automatic temperature setting, operation mode setting, cooling mode setting, and heating mode setting as the specific control to be performed on the control target device 31 or 32. In the example illustrated in FIG. 8A, the power on-off setting, the automatic temperature setting, and the operation mode setting are selected as search keys.

When the user selects the checkbox image CHK14 and then the button image BU13 with the input device 705, with the search screen image GA1 illustrated in FIG. 7 displayed on the display 704, a search screen image GA3 illustrated in FIG. 8B is displayed on the display 704. The search screen image GA3 includes checkbox images CHK31, CHK32, CHK33, CHK34, CHK35, and CHK36, and a button image BU31 displaying Search to be selected to perform a search. The checkbox images CHK31, CHK32, CHK33, CHK34, CHK35, and CHK36 are used as search keys together with the operation device ID name to respectively select the power on-off setting, the temperature setting, the automatic temperature setting, the operation mode setting, the cooling mode setting, and the heating mode setting as the specific control to be performed on the control target device 31 or 32. In the example illustrated in FIG. 8B, the power on-off setting, the automatic temperature setting, and the operation mode setting are used as search keys.

As illustrated in FIG. 6, when the user performs the above search key specifying operation and search start operation with the search screen image displayed on the display 704 in the terminal 7, the terminal 7 generates the above search condition information (step S12). In the search key specifying operation, as described above, the user specifies, with the input device 705, the operation device ID name, the control target device ID name, and the specific control used as search keys with the search screen image displayed on the display 704 in the terminal 7. In the search start operation, for example, the user selects, with the input device 705, the button image BU13 without selecting the checkbox image CHK11, CHK12, CHK13, or CHK14 or after selecting the checkbox images CHK11 and CHK 13 with the search screen image GA1 illustrated in FIG. 7 displayed on the display 704. In the search start operation, for example, the user selects, with the input device 705, at least one of the checkbox image CHK21, CHK22, CHK23, CHK24, CHK25, or CHK26 and then the button image BU21 with the search screen image GA2 illustrated in FIG. 8A displayed on the display 704. Alternatively, the user selects, with the input device 705, at least one of the checkbox image CHK31, CHK32, CHK33, CHK34, CHK35, or CHK36 and then the button image BU31 with the search screen image GA3 illustrated in FIG. 8B displayed on the display 704.

In an example, the user selects, with the input device 705, the operation device ID name and the control target device ID name used as search keys without selecting any of the checkbox image CHK11, CHK12, CHK13 or CHK14 and then selects the button image BU13 with the search screen image GA1 illustrated in FIG. 7 displayed on the display 704 in the terminal 7. In this case, the terminal 7 generates the search condition information including the operation device ID name information and the control target device ID name information used as search keys. In an example, the user selects, with the input device 705, the control target device ID name used as a search key and the checkbox image CHK11 and then selects the button image BU13 with the search screen image GA1 illustrated in FIG. 7 displayed on the display 704 in the terminal 7. In this case, the terminal 7 generates the search condition information simply including the control target device ID name information used as a search key. In an example, the user selects, with the input device 705, the operation device ID name used as a search key and the checkbox image CHK13 and then selects the button image BU13 with the search screen image GA1 illustrated in FIG. 7 displayed on the display 704 in the terminal 7. In this case, the terminal 7 generates the search condition information simply including the operation device ID name information used as a search key. In an example, the user selects, with the input device 705, the specific control used as a search key and then the button image BU21 with the search screen image GA2 illustrated in FIG. 8A displayed on the display 704 in the terminal 7. In this case, the terminal 7 generates the search condition information including the control target device ID name information and the specific control information used as search keys. In an example, the user selects, with the input device 705, the specific control used as a search key and then the button image BU31 with the search screen image GA3 illustrated in FIG. 8B displayed on the display 704 in the terminal 7. In this case, the terminal 7 generates the search condition information including the operation device ID name information and the specific control information used as search keys. Referring back to FIG. 6, the generated search condition information is then transmitted from the terminal 7 to the operation device management server 1 (step S13).

When acquiring the search condition information, the operation device management server 1 searches for at least one of the control target device ID name information, the operation device ID name information, or the specific control information based on the acquired search condition information (step S14). The operation device management server 1 searches for the control target device ID name information of the control target device 32 (31) having a record of being controlled through an operation performed on the operation device 52 (51) of the same type as the operation device 51 (52) that is operated by the user based on the search condition information. Alternatively, the operation device management server 1 searches for the operation device ID name information of the operation device 52 (51) having a record of being operated to control the control target device 32 (31) of the same type as the control target device 31 (32) that is to be controlled by the user based on the search condition information. When searching for the control target device ID name information of the control target device 32 (31) having a record of being controlled through an operation performed on the operation device 52 (51) of the same type as the operation device 51 (52) that is operated by the user based on the search condition information and detecting no control target device ID name information, the operation device management server 1 searches for the control target device ID name information of the control target device 32 (31) with the same class code information assigned as the class code information of the control target device 32 (31). When searching for the control target device ID name information of the control target device 32 (31) with the same class code information assigned as the class code information of the control target device 32 (31) and detecting no control target device ID name information, the operation device management server 1 searches for the control target device ID name information of the control target device 32 (31) with the same class group code information assigned as the class group code information of the control target device 32 (31).

When detecting at least one of the control target device ID name information, the operation device ID name information, or the specific control information through the search, the operation device management server 1 generates the search result information including at least one of the control target device ID name information, the operation device ID name information, or the specific control information that has been detected (step S15). When detecting none of the control target device ID name information, the operation device ID name information, or the specific control information through the search, the operation device management server 1 generates the search result information including the URL information described above. The generated search result information is then transmitted from the operation device management server 1 to the terminal 7 (step S16).

When acquiring the search result information, the terminal 7 extracts at least one of the control target device ID information, the operation device ID information, or the specific control information included in the acquired search result information, generates a search result display screen image based on at least one of the control target device ID information, the operation device ID information, or the specific control information that has been extracted, and causes the display 704 to display the search result display screen image on the display 704 (step S17).

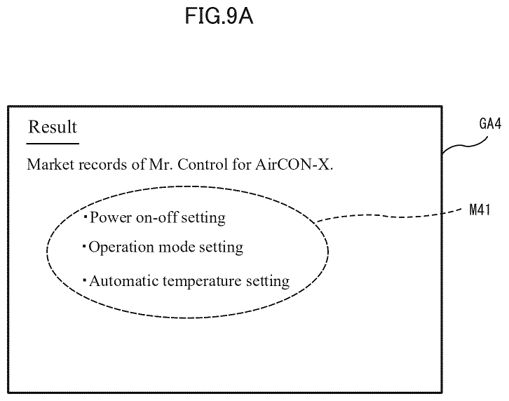

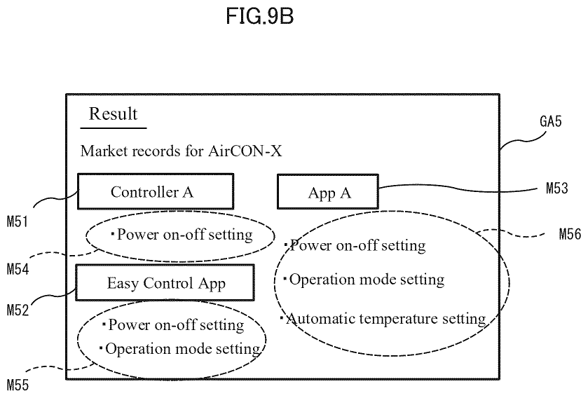

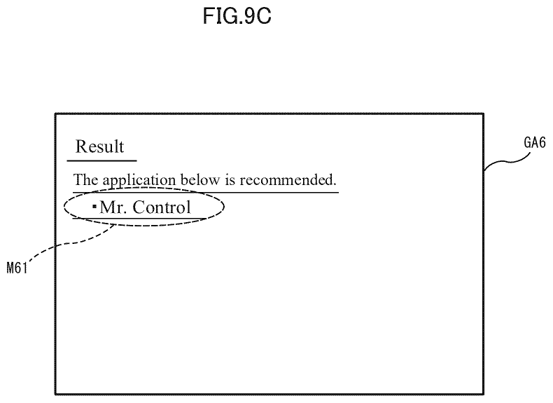

When the search condition information transmitted to the operation device management server 1 includes the operation device ID name information and the control target device ID name information used as search keys, the terminal 7 acquires the search result information including the specific control information detected through the search using the operation device ID name information and the control target device ID name information as search keys. The terminal 7 then generates, for example, a search result display screen image GA4 illustrated in FIG. 9A including a message M41 indicating the detected specific control and causes the display 704 to display the search result display screen image GA4. When the search condition information transmitted to the operation device management server 1 simply includes the control target device ID name information used as a search key, the terminal 7 acquires the search result information including the operation device ID name information and the specific control information detected through the search using the control target device ID name information as a search key. The terminal 7 then generates, for example, a search result display screen image GA5 illustrated in FIG. 9B including, in a manner associated with one another, a message M51 indicating the detected operation device ID name information of the detected operation device 51 or 52 and messages M52 and M53 each indicating the operation device ID name information, and messages M54, M55, and M56 each indicating the specific control information indicating the specific control performed with the operation device 51 or 52, or the operation device application, and causes the display 704 to display the search result display screen image GA5. When the search condition information transmitted from the operation device management server 1 includes the control target device ID name information and the specific control information used as search keys, the terminal 7 acquires the search result information including the operation device ID name information detected through the search using the control target device ID name information and the specific control information as search keys. The terminal 7 then generates, for example, a search result display screen image GA6 illustrated in FIG. 9C including a message M61 indicating the detected operation device ID name information and causes the display 704 to display the search result display screen image GA6.

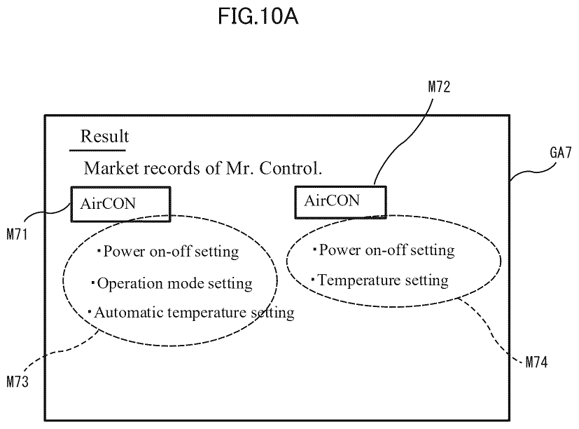

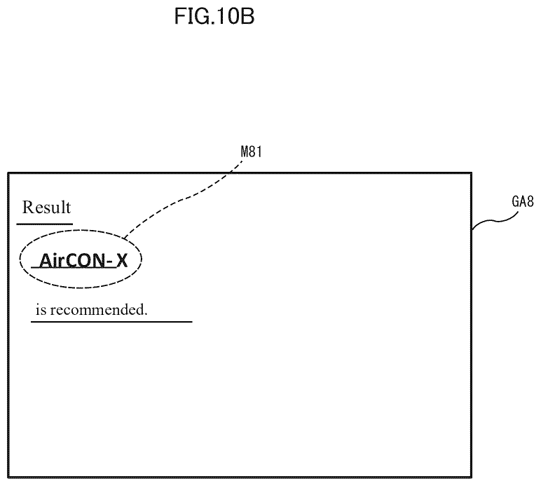

When the search condition information transmitted from the operation device management server 1 simply includes the operation device ID name information used as a search key, the terminal 7 acquires the search result information including the control target device ID name information and the specific control information detected through the search using the operation device ID name information as a search key. The terminal 7 then generates, for example, a search result display screen image GA7 illustrated in FIG. 10A including, in a manner associated with one another, messages M71 and M72 each indicating the detected control target device ID name information and messages M73 and M74 each indicating the specific control information performed on each control target device 31 or 32 and causes the display 704 to display the search result display screen image GA7. When the search condition information transmitted from the operation device management server 1 includes the operation device ID name information and the specific control information used as search keys, the terminal 7 acquires the search result information including the control target device ID name information detected through the search using the operation device ID name information and the specific control information as search keys. The terminal 7 then generates, for example, a search result display screen image GA8 illustrated in FIG. 10B including a message M81 indicating the detected control target device ID name information and causes the display 704 to display the search result display screen image GA8.

When the acquired search result information includes the URL information of a website managed by the product list management server 8, the terminal 7 extracts the URL information from the search result information and acquires the webpage information from the product list management server 8 based on the extracted URL information. The terminal 7 then generates, based on the acquired webpage information, a webpage image showing a list of control target device ID names recommended by the manufacturer of the operation device application or a list of operation device ID names recommended by the manufacturer of the control target device 31 or 32, and causes the display 704 to display the webpage image.

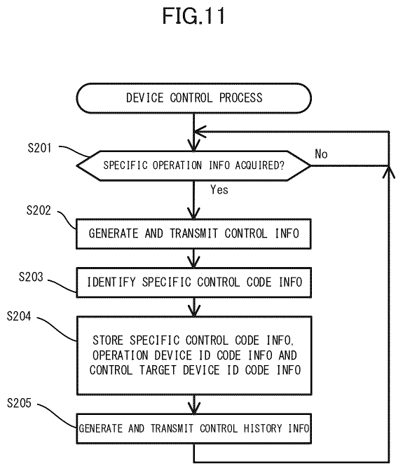

A device control process performed by the cloud server 21 or 22 in the present embodiment for controlling the control target device 31 or 32 based on the specific operation information acquired from the operation device 51 or 52 is now described with reference to FIG. 11. The device control process starts in response to the activation of a program for performing the device control process in the cloud server 21 or 22. The device controller 211 first determines whether the specific operation information transmitted from the operation device 51 or 52 is acquired (step S201). Each time the device controller 211 determines that no specific operation information is acquired (No in step S201), the device controller 211 repeats the processing in step S201. When determining that the specific operation information is acquired (Yes in step S201), the device controller 211 generates the control information for controlling the control target device 31 or 32 based on the acquired specific operation information and transmits the control information to the control target device 31 or 32 (step S202). The device controller 211 then identifies the specific control code information corresponding to the generated control information (step S203). Subsequently, the device controller 211 causes the control history storage 231 to store, in a manner associated with one another, the identified specific control code information, the operation device ID code information of the operation device 51 or 52 that is the source of the specific operation information or the operation device application activated on the operation device 51 or 52, or the operation device ID code information of the operation device 51 or 52, and the control target device ID code information of the control target device 31 or 32 that is the destination of the control information. The control history notifier 212 then generates the control history information including the specific control code information, the operation device ID code information, and the control target device ID code information stored in the control history storage 231 and transmits the generated control history information to the operation device management server 1 (step S205). The processing in step S201 is then performed again.

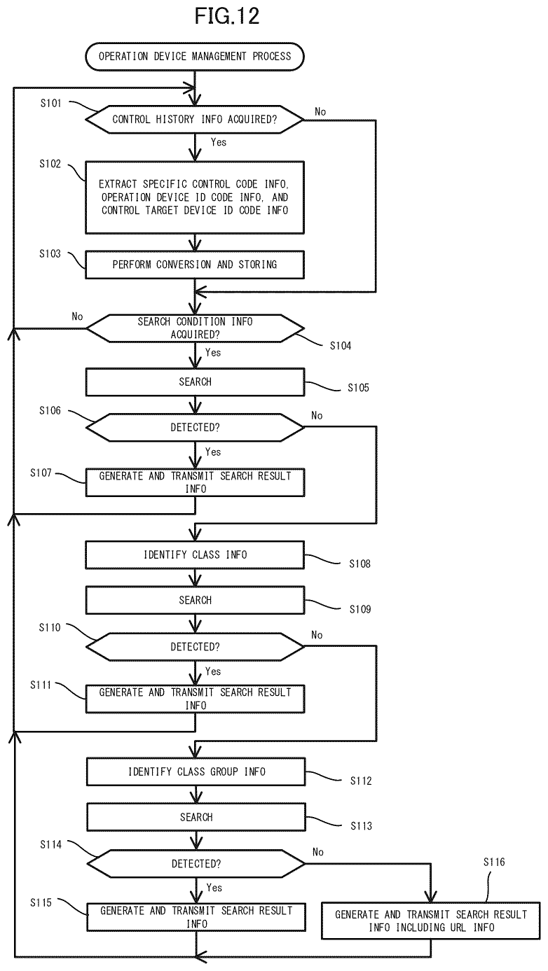

An operation device management process performed by the operation device management server 1 according to the present embodiment is now described with reference to FIG. 12. The operation device management process starts in response to the activation of a program for performing the operation device management process in the operation device management server 1. The control history acquirer 111 first determines whether the control history information transmitted from the cloud server 21 or 22 is acquired (step S101). When the control history acquirer 111 determines that no control history information is acquired (No in step S101), the processing in step S104 (described later) is performed. When determining that the control history information is acquired (Yes in step S101), the control history acquirer 111 extracts the specific control code information, the operation device ID code information, and the control target device ID code information included in the acquired control history information (step S102). The converter 112 then refers to the information stored in the master information storage 131 to convert the extracted specific control code information, operation device ID code information, and control target device ID code information respectively to the specific control information, the operation device ID name information, and the control target device ID name information, and causes the control record storage 132 to store the resultant sets of information (step S103).

Subsequently, the search condition acquirer 113 determines whether the search condition information transmitted from the terminal 7 is acquired (step S104). When the search condition acquirer 113 determines that no search condition information is acquired (No in step S104), the processing in step S101 is performed again. In an example, the search condition acquirer 113 determines that the search condition information is acquired (Yes in step S104). In this case, the searcher 114 searches for at least one of the control target device ID name information, the operation device ID name information, and the specific control information based on the acquired search condition information (step S105). The searcher 114 performs the search using the operation device ID name information, the control target device ID name information, or the specific control information included in the search condition information as a search key. The searcher 114 then determines whether at least one of the operation device ID name information, the control target device ID name information, or the specific control information is detected through the search (step S106). In an example, the searcher 114 determines that at least one of the operation device ID name information, the control target device ID name information, or the specific control information is detected (Yes in step S106). In this case, the search result notifier 115 generates the search result information including at least one of the control target device ID name information, the operation device ID name information, or the specific control information that has been detected, and transmits the search result information to the terminal 7 (step S107). The processing in step S101 is then performed again.

In an example, the searcher 114 determines that none of the operation device ID name information, the control target device ID name information, or the specific control information is detected (No in step S106). In this case, the searcher 114 refers to the class information stored in the master information storage 131 to identify the class information corresponding to the operation device ID name information or the control target device ID name information used as a search key (step S108). The searcher 114 then searches the various information items stored in the control record storage 132 for the operation device ID name information and the control target device ID name information corresponding to the identified class information (step S109). Subsequently, the searcher 114 determines whether at least one of the operation device ID name information, the control target device ID name information, or the specific control information is detected through the search (step S110). In an example, the searcher 114 determines that at least one of the operation device ID name information, the control target device ID name information, or the specific control information is detected (Yes in step S110). In this case, the search result notifier 115 generates the search result information including at least one of the control target device ID name information, the operation device ID name information, or the specific control information that has been detected, and transmits the search result information to the terminal 7 (step S111). The processing in step S101 is then performed again.

In an example, the searcher 114 determines that none of the operation device ID name information, the control target device ID name information, or the specific control information is detected (No in step S110). In this case, the searcher 114 refers to the class group information stored in the master information storage 131 to identify the class group information corresponding to the operation device ID name information or the control target device ID name information used as a search key (step S112). The searcher 114 then searches the various information items stored in the control record storage 132 for the operation device ID name information or the control target device ID name information corresponding to the identified class group information (step S113). The searcher 114 then determines whether at least one of the operation device ID name information, the control target device ID name information, or the specific control information is detected through the search (step S114). In an example, the searcher 114 determines that at least one of the operation device ID name information, the control target device ID name information, or the specific control information is detected (Yes in step S114). In this case, the search result notifier 115 generates the search result information including at least one of the control target device ID name information, the operation device ID name information, or the specific control information that has been detected, and transmits the search result information to the terminal 7 (step S115). The processing in step S101 is then performed again.

In an example, the searcher 114 determines that none of the operation device ID name information, the control target device ID name information, or the specific control information is detected (No in step S114). In this case, the search result notifier 115 generates the search result information including the URL information indicating the URL of a website managed by the product list management server 8 and transmits the search result information to the terminal 7 (step S116). The processing in step S101 is then performed again.

In the operation device management system according to the present embodiment, as described above, the searcher 114 searches for, based on the search condition information, at least one of the control target device ID name information of the control target device 31 or 32 controllable with the operation device 51 or 52 operated by the user, the operation device ID name information of the operation device 51 or 52 that can control the control target device when operated by a user, or the specific control information indicating the specific control having a record of being performed on the control target device. When at least one of the control target device ID name information, the operation device ID name information, or the specific control information is detected, the search result notifier 115 generates the search result information including at least one of the control target device ID name information, the operation device ID name information, or the specific control information that has been detected and transmits the search result information to the terminal 7. With this system, for the operation device 51 or 52 owned by the user, the control target device 31 or 32 having a record of combined use with the operation device 51 or 52 in previous operations performed on the control target device 31 or 32 can be presented to the user, and for the control target device 31 or 32 owned by the user, the operation device 51 or 52 having a record of combined use with the control target device 31 or 32 in previous operations performed on the control target device 31 or 32 can be presented to the user. The user can thus appropriately determine the optimum operation device 51 or 52 for operating the control target device 31 or 32 owned by the user or the optimum control target device 31 or 32 to be controlled through an operation performed on the operation device 51 or 52 owned by the user.

Techniques have recently been developed for controlling the control target device 31 or 32 with the cloud server 21 or 22 through the wide area network NW1 as described above. Techniques have also been developed for controlling the control target device 31 or 32 with a smartphone on which the operation device application is activated, or for operating the control target device 31 or 32 with a control device connected to the local area network NW21 or NW22 to which the control target device 31 or 32 is connected. The manufacturers of the multiple control target devices 31 and 32 or the operation devices 51 and 52 have been provided the control target devices 31 and 32 or the operation devices 51 and 52 based on standardized communication standards such as ECHONET Lite (registered trademark). Thus, the operation device 51 or 52 with a manufacturer different from the manufacturer of the control target device 31 or 32 has been increasingly used as the operation device 51 or 52 for operating the control target device 31 or 32. Additionally, version updates may add new functions to or remove old functions from the operation device applications that are activated on the operation devices 51 and 52. A technique has thus been awaited for the user to easily determine the compatibility between the operation device 51 or 52 and the control target device 31 or 32.

The operation device management system according to the present embodiment can present, to the user, the operation device 51 or 52 having a record of combined use with the control target device 31 or 32 in previous operations performed on the control target device 31 or 32, or the control target device 31 or 32 having a record of combined use with the operation device 51 or 52 in previous operations performed on the control target device 31 or 32. The user can thus appropriately determine a combination of the operation device 51 or 52 and the control target device 31 or 32 with such a previous record as having high compatibility.

Additionally, the control record storage 132 in the present embodiment stores the class information indicating the class of the control target device 31 or 32 as classified based on the type of the control target device 31 or 32 in a manner associated with the control target device ID name information of the corresponding control target device 31 or 32. When searching for at least one of the operation device ID name information or the control target device ID name information based on the search condition and not detecting the operation device ID name information or the control target device ID name information, the searcher 114 searches for at least one of the operation device ID name information of the operation device or the control target device ID name information of the control target device in the same class as at least one of the operation device being a search target or the control target device being a search target. This can eliminate resetting the operation device ID name information or the control target device ID name information used as a search key by the user, thus reducing the operation load on the user.

Additionally, when the control target device ID name information or the operation device ID name information is not detected, the search result notifier 115 generates the search result information including the URL information indicating the URL of a website managed by the product list management server 8 and transmits the search result information to the terminal 7. This can eliminate searching for a website showing an associated product list by the user when the control target device ID name information or the operation device ID name information is not detected.

Although the embodiment of the present disclosure has been described above, the present disclosure is not limited to the above embodiment. For example, the user may select, as a search key, the class information indicating the class of the operation device 51 or 52 or the control target device 31 or 32, or the class group information indicating the class group of the operation device 51 or 52 or the control target device 31 or 32. The searcher 114 may then search for at least one of the specific control information, the operation device ID name information, or the control target device ID name information using at least one of all operation devices 51 and 52, or all control target devices 31 and 32 in the selected class as search keys. For example, when the class including the operation device 51 or 52 is selected, the searcher 114 searches for at least one of the specific control information or the control target device ID name information using all operation devices 51 and 52 in the selected class as search keys.

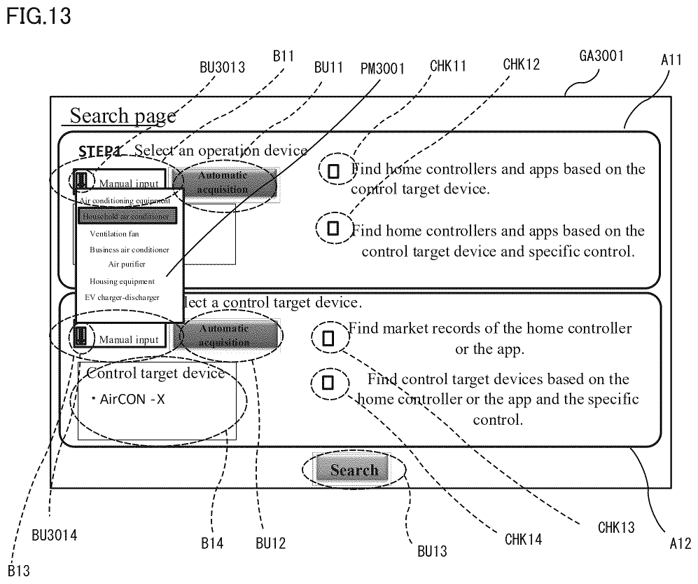

In the present modification, the terminal 7 may cause the display 704 to display, for example, a search screen image GA3001 illustrated in FIG. 13. In FIG. 13, like reference signs denote like components in FIG. 7 in the embodiment. The search screen image GA3001 includes a button image BU3013 to be selected to display a pop-up menu image PM3001 located adjacent to the left end of the input field B11 for inputting the operation device name used as a search key, and a button image BU3014 to be selected to display a pop-up menu image PM3001 located adjacent to the left end of the input field B13 for inputting the control target device ID name used as a search key. When the user selects, with the input device 705, the button image BU3013 or BU3014 with the search screen image GA3001 displayed on the display 704 in the terminal 7, the pop-up menu image PM3001 is displayed. In the example illustrated in FIG. 13, the pop-up menu image PM3001 includes pre-registered class names of Household air conditioner, Ventilation fan, Business air conditioner, Air purifier, and EV charger-discharger each indicating a class of the control target device 31 or 32 and pre-registered class group names of Air conditioning equipment and Housing equipment each indicating a class group.

This structure allows a search using the class or the class group of the operation device 51 or 52, or the control target device 31 or 32, thus improving the search efficiency for the user.

In the embodiment, the converter 112 converts the specific control code information, the operation device ID code information, and the control target device ID code information respectively to the specific control information, the operation device ID name information, and the control target device ID name information, and causes the control record storage 132 to store the resultant sets of information. The searcher 114 then searches for at least one of the control target device ID name information, the operation device ID name information, or the specific control information based on the search condition information. In some embodiments, however, the searcher may search for at least one of the specific control code information, the operation device ID code information, or the control target device ID code information based on the search condition information, and the converter may convert at least one of the specific control code information, the operation device ID code information, or the control target device ID code information that has been detected to the specific control information, the operation device ID name information, or the control target device ID name information.

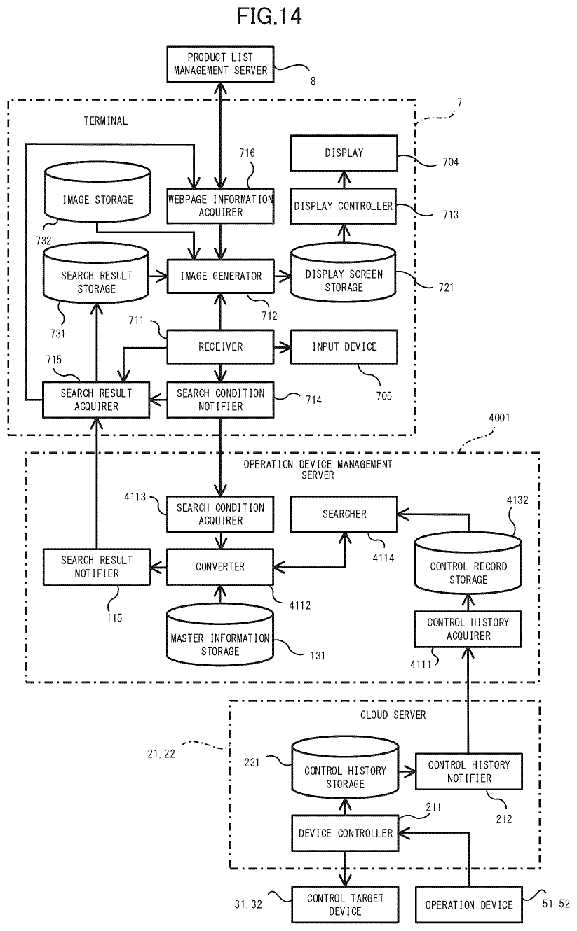

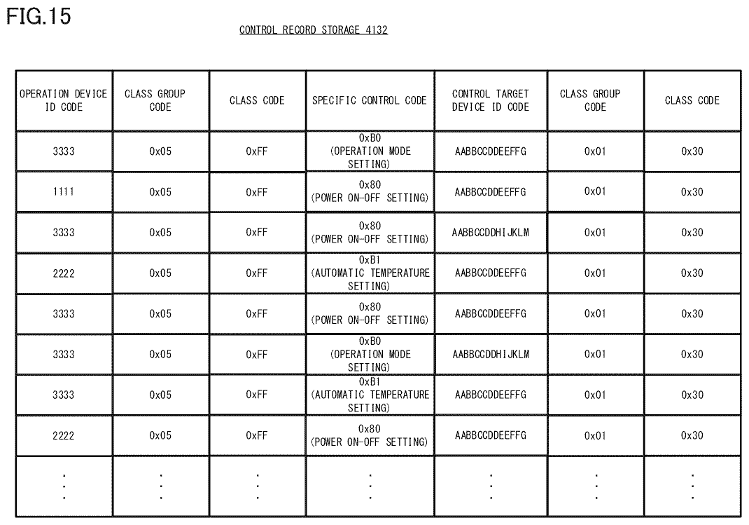

As illustrated in FIG. 14, an operation device management server 4001 according to the present modification has the same hardware configuration as the operation device management server 1 described in the embodiment, and functions as a control history acquirer 4111, a converter 4112, a search condition acquirer 4113, a searcher 4114, and a search result notifier 115. In FIG. 14, like reference signs denote like components in FIG. 3 in the embodiment. The operation device management server 4001 includes a master information storage 131 and a control record storage 4132. As illustrated in FIG. 15, for example, the control record storage 4132 stores the specific control code information indicating the specific control performed on the control target device 31 or 32 through an operation performed previously on the operation device 51 or 52, together with the operation device ID code information of the corresponding operation device 51 or 52 and the control target device ID code information of the control target device 31 or 32, in a manner associated with the class code information and the class group code information of the operation device 51 or 52 and the control target device 31 or 32.

Referring back to FIG. 14, the control history acquirer 4111 acquires the control history information transmitted from the cloud server 21 or 22, extracts the specific control code information, the operation device ID code information, and the control target device ID code information included in the acquired control history information, and causes the control record storage 4132 to store the extracted sets of information in a manner associated with one another.

When acquiring the search condition information transmitted from the terminal 7, the search condition acquirer 4113 provides the acquired search condition information to the converter 4112.

When acquiring the search condition information from the search condition acquirer 4113, the converter 4112 refers to the information stored in the master information storage 131 to convert at least one of the operation device ID name information, the control target device ID name information, or the specific control information used as a search key included in the search condition information to the operation device ID code information, the control target device ID code information, or the specific control code information. The converter 4112 then provides the operation device ID code information, the control target device ID code information, or the specific control code information to the searcher 4114. When at least one of the operation device ID code information, the control target device ID code information, or the specific control code information that has been detected by the searcher 4114 is provided from the searcher 4114, the converter 4112 refers to the information stored in the master information storage 131 to convert at least one of the operation device ID code information, the control target device ID code information, or the specific control code information that has been provided to the operation device ID name information, the control target device ID name information, or the specific control information. The converter 4112 then provides the operation device ID name information, the control target device ID name information, or the specific control information to the search result notifier 115.

The searcher 4114 searches for the control target device ID code information of the control target device 32 (31) having a record of being controlled through an operation performed on the operation device 52 (51) of the same type as the operation device 51 (52) that is operated by the user based on at least one of the operation device ID code information, the control target device ID code information, or the specific control code information used as a search key provided from the converter 4112. Alternatively, the searcher 4114 searches for the operation device ID code information of the operation device 52 (51) or the operation device application having a record of being operated to control the control target device 32 (31) of the same type as the control target device 31 (32) that is to be controlled by the user. Alternatively, the searcher 4114 searches for the specific control code information indicating the specific control performed on the control target device 32 (31) of the same type as the control target device 31 (32) intended to be controlled by the user with the operation device 52 (51) of the same type as the operation device 51 (52) operated by the user. When detecting at least one of the control target device ID code information, the operation device ID code information, or the specific control code information through the search, the searcher 4114 provides at least one of the control target device ID code information, the operation device ID code information, or the specific control code information that has been detected to the converter 4112.

When at least one of the control target device ID name information, the operation device ID name information, or the specific control information is provided from the converter 4112, the search result notifier 115 generates the search result information including the provided control target device ID name information or the operation device ID name information and transmits the search result information to the terminal 7.

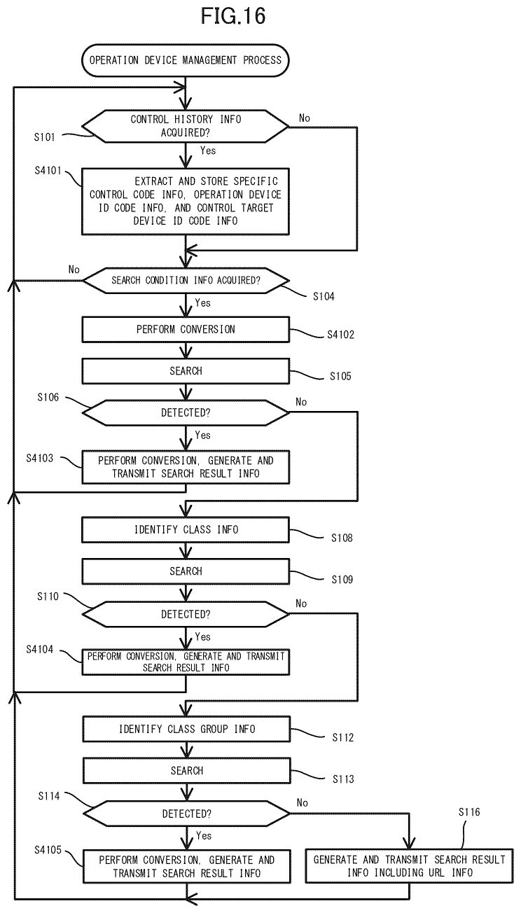

An operation device management process performed by the operation device management server 4001 according to the present modification is now described with reference to FIG. 16. In the operation device management process illustrated in FIG. 16, like reference signs denote like processing in FIG. 12 in the embodiment. The control history acquirer 4111 first determines whether the control history information transmitted from the cloud server 21 or 22 is acquired (step S101). When the control history acquirer 4111 determines that no control history information is acquired (No in step S101), the processing in step S104 (described later) is performed. When determining that the control history information is acquired (Yes in step S101), the control history acquirer 4111 extracts the specific control code information, the operation device ID code information, and the control target device ID code information included in the acquired control history information and causes the control record storage 4132 to store the extracted sets of information (step S4101).

The search condition acquirer 4113 then determines whether the search condition information transmitted from the terminal 7 is acquired (step S104). When the search condition acquirer 4113 determines that no search condition information is acquired (No in step S104), the processing in step S101 is performed again. In an example, the search condition acquirer 4113 determines that the search condition information is acquired (Yes in step S104). In this case, the converter 4112 refers to the information stored in the master information storage 131 to convert at least one of the operation device ID name information, the control target device ID name information, or the specific control information used as a search key included in the acquired search condition information to the operation device ID code information, the control target device ID code information, or the specific control code information (step S4102). Subsequently, the searcher 4114 searches for at least one of the control target device ID code information, the operation device ID code information, or the specific control code information based on at least one of the operation device ID code information, the control target device ID code information, or the specific control code information used as a search key provided from the converter 4112 (step S105). The searcher 4114 then determines whether at least one of the operation device ID code information, the control target device ID code information, or the specific control code information is detected through the search (step S106). In an example, the searcher 4114 determines that at least one of the operation device ID code information, the control target device ID code information, or the specific control code information is detected (Yes in step S106). In this case, the converter 4112 refers to the information stored in the master information storage 131 to convert at least one of the operation device ID code information, the control target device ID code information, or the specific control code information that has been detected to the operation device ID name information, the control target device ID name information, or the specific control information. The search result notifier 115 generates the search result information including at least one of the device ID name information, the operation device ID name information, or the specific control information that has been converted and transmits the search result information to the terminal 7 (step S4103). The processing in step S101 is then performed again.

In an example, the searcher 4114 determines that none of at least one of the operation device ID code information, the control target device ID code information, or the specific control code information is detected (No in step S106). In this case, a series of processing from step S108 to step S110 is performed. In an example, the searcher 4114 then determines, in step S110, that at least one of the operation device ID code information, the control target device ID code information, or the specific control code information is detected (Yes in step S110). In this case, the converter 4112 refers to the information stored in the master information storage 131 to convert at least one of the operation device ID code information, the control target device ID code information, or the specific control code information that has been detected to the operation device ID name information, the control target device ID name information, or the specific control information. The search result notifier 115 generates the search result information including at least one of the control target device ID name information, the operation device ID name information, or the specific control information that has been converted and transmits the search result information to the terminal 7 (step S4104). The processing in step S101 is then performed again.

In an example, the searcher 4114 determines that none of the operation device ID name information, the control target device ID name information, or the specific control information is detected (No in step S110). In this case, a series of processing from step S112 to step S114 is performed. In an example, the searcher 4114 then determines, in step S114, that at least one of the operation device ID code information, the control target device ID code information, or the specific control code information is detected (Yes in step S114). In this case, the converter 4112 refers to the information stored in the master information storage 131 to convert at least one of the operation device ID code information, the control target device ID code information, or the specific control code information that has been detected to the operation device ID name information, the control target device ID name information, or the specific control information. In this case, the search result notifier 115 generates the search result information including at least one of the device ID name information, the operation device ID name information, or the specific control information that has been detected, and transmits the search result information to the terminal 7 (step S4105). The processing in step S101 is then performed again.

When the searcher 4114 determines that none of the operation device ID name information, the control target device ID name information, or the specific control information is detected (No in step S114), the processing in step S116 is performed.

With this structure, the operation device ID code information, the control target device ID code information, or the specific control code information detected by the searcher 4114 alone is converted to the operation device ID name information, the control target device ID name information, or the specific control information. This can reduce the number of information items to be converted among the operation device ID code information, the control target device ID code information, and specific control code information, thus reducing the conversion load on the converter 4112.

In some embodiments, the terminal 7 may include an ID information acquirer that acquires the operation device ID name information of all operation devices 51 and 52 connected to the local area networks NW21 and NW22 to which the terminal 7 is connected, or the operation device ID name information of all operation device applications activated on the operation devices 51 and 52, and the control target device ID name information of all control target devices 31 and 32. When the ID information acquirer acquires the operation device ID name information of all operation devices 51 and 52 or the operation device ID name information of all operation device applications activated on the operation devices 51 and 52 and the control target device ID name information, the search condition notifier 714 may generate, based on the acquired sets of information, the search condition information using the acquired sets of information as search keys and transmit the search condition information to the operation device management server 1. In some embodiments, the ID information acquirer may acquire the operation device ID code information of the operation device 51 or 52 connected to the local area network NW21 or NW22 to which the terminal 7 is connected, and the control target device ID code information of the control target device 31 or 32.

This structure can eliminate inputting the operation device ID name, the application ID name, or the control target device ID name used as a search key, thus improving the search efficiency for the user.

The functions of the operation device management server 1 or 4001, the cloud servers 21 and 22, and the terminal 7 according to one or more embodiments of the present disclosure may be implemented with a common computer system, rather than with a dedicated system. For example, a computer connected to a network may store a program for performing the above operations in a non-transitory computer-readable recording medium (for example, a compact disc read-only memory, or CD-ROM) for distribution. The program may be installed in the computer system to implement the operation device management server 1 or 4001, the cloud servers 21 and 22, and the terminal 7 that perform the above processing.

The program may be provided to the computer in any manner. For example, the program may be uploaded to a bulletin board system (BBS) through a communication line and distributed to a computer. The computer then activates the program and executes the program in the same manner as other applications under the control of the operating system (OS). The computer thus functions as the operation device management server 1 or 4001, the cloud servers 21 and 22, and the terminal 7.

Although the embodiment of the present disclosure and the modifications of the embodiment have been described above, the present disclosure is not limited to the embodiment and the modifications. The present disclosure includes the embodiment and the modifications combined as appropriate and changed as appropriate.

### INDUSTRIAL APPLICABILITY

One or more embodiments of the present disclosure are applicable to an operation device management system that presents the compatibility between an operation device and a control target device to be controlled through an operation on the operation device.

1. An operation device management system, comprising:
a terminal; and
a control device, wherein
the control device includes
a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed, and
first processing circuitry to
acquire search condition information transmitted from the terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device,
search the control target device identification information, the operation device identification information, and the specific control information stored in the control record storage for at least one of the control target device identification information, the operation device identification information, or the specific control information based on the search condition information, and
generate, when at least one of the control target device identification information, the operation device identification information, or the specific control information is detected, search result information including at least one of the detected control target device identification information, the detected operation device identification information, or the detected specific control information, and transmit the search result information to the terminal,
the control record storage further stores, in a manner associated with the control target device identification information, class information indicating a class of the at least one control target device classified based on a type of the at least one control target device, and
when searching for at least one of the operation device identification information or the control target device identification information based on the search condition and not detecting the operation device identification information or the control target device identification information, the first processing circuitry searches for at least one of operation device identification information of an operation device or control target device identification information of a control target device in a same class as at least one of the operation device being a search target or the control target device being a search target.

2. The operation device management system according to claim 1, wherein
the search condition information includes at least one of the operation device identification information, the control target device identification information, or the specific control information used as a search key.

3. The operation device management system according to claim 2, wherein
the control record storage further stores, in a manner associated with the control target device identification information, class information indicating a class of the at least one control target device classified based on a type of the at least one control target device.

4. The operation device management system according to claim 2, wherein
when searching for at least one of the operation device identification information or the control target device identification information based on the search condition and not detecting the operation device identification information or the control target device identification information, the first processing circuitry searches for at least one of operation device identification information of an operation device or control target device identification information of a control target device in a same class as at least one of the operation device being a search target or the control target device being a search target.

5. The operation device management system according to claim 1, wherein
the first processing circuitry transmits, when the control target device identification information or the operation device identification information is detected, uniform resource locator information indicating a predetermined uniform resource locator to the terminal.

6. The operation device management system according to claim 1, wherein
the first processing circuitry
controls, when acquiring, from the operation device, specific operation information indicating a specific operation performed on the operation device by the user, the at least one control target device based on the acquired specific operation information,
acquires control history information including specific control information expressing the specific control performed on the at least one control target device in a first format, operation device identification information identifying the operation device operated by the user and expressed in the first format, and control target device identification information identifying the at least one control target device and expressed in the first format, and
converts the specific control information, the operation device identification information, and the control target device identification information included in the control history information respectively to specific control information, operation device identification information, and control target device identification information expressed in a second format different from the first format, and causes the control record storage to store the specific control information, the operation device identification information, and the control target device identification information expressed in the second format.

7. The operation device management system according to claim 3, wherein
the first processing circuitry
controls, when acquiring, from the operation device, specific operation information indicating a specific operation performed on the operation device by the user, the at least one control target device based on the acquired specific operation information,
acquires control history information including specific control information expressing the specific control performed on the at least one control target device in a first format, operation device identification information identifying the operation device operated by the user and expressed in the first format, and control target device identification information identifying the at least one control target device and expressed in the first format, and
converts, when the searcher detects the control target device identification information or the operation device identification information, the detected control target device identification information or the detected operation device identification information to control target device identification information or operation device identification information expressed in a second format different from the first format,
the control record storage stores the specific control information, the operation device identification information, and the control target device identification information in the first format in a manner associated with one another,
the first processing circuitry searches for the control target device identification information or the operation device identification information expressed in the first format based on the search condition information including the operation device identification information and the specific control information expressed in the first format or including the control target device identification information and the specific control information expressed in the first format, and
the first processing circuitry transmits, to the terminal, the operation device identification information or the control target device identification information resulting from conversion and expressed in the second format.

8. The operation device management system according to claim 1, wherein
the terminal includes
second processing circuitry to
acquire operation device identification information of an operation device connected to a local area network to which the terminal is connected, and control target device identification information of a control target device connected to the local area network, and
generate and transmit the search condition information including at least one of the acquired operation device identification information or the acquired control target device identification information.

9. An operation device management apparatus, comprising:
a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed, and
processing circuitry to
acquire search condition information transmitted from a terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device,
a search the control target device identification information, the operation device identification information, and the specific control information stored in the control record storage for at least one of the control target device identification information, the operation device identification information, or the specific control information based on the search condition information, and
generate, when at least one of the control target device identification information, the operation device identification information, or the specific control information is detected, search result information including at least one of the detected control target device identification information, the detected operation device identification information, or the detected specific control information, and transmit the search result information to the terminal, wherein
the control record storage further stores, in a manner associated with the control target device identification information, class information indicating a class of the at least one control target device classified based on a type of the at least one control target device, and
when searching for at least one of the operation device identification information or the control target device identification information based on the search condition and not detecting the operation device identification information or the control target device identification information, the processing circuitry searches for at least one of operation device identification information of an operation device or control target device identification information of a control target device in a same class as at least one of the operation device being a search target or the control target device being a search target.

10. An operation device management method, comprising:
causing, by a control device, a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed;
acquiring, by the control device, search condition information transmitted from a terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device;
searching, by the control device, the control target device identification information, the operation device identification information, and the specific control information stored in the control record storage for at least one of the control target device identification information, the operation device identification information, or the specific control information based on the search condition information; and
generating, by the control device, when at least one of the control target device identification information, the operation device identification information, or the specific control information is detected, search result information including at least one of the detected control target device identification information, the detected operation device identification information, or the detected specific control information, and transmitting, by the control device, the search result information to the terminal, wherein
the control record storage further stores, in a manner associated with the control target device identification information, class information indicating a class of the at least one control target device classified based on a type of the at least one control target device, and
when searching for at least one of the operation device identification information or the control target device identification information based on the search condition and not detecting the operation device identification information or the control target device identification information, the control device searches for at least one of operation device identification information of an operation device or control target device identification information of a control target device in a same class as at least one of the operation device being a search target or the control target device being a search target.

11. A non-transitory recording medium storing a program, the program causing a computer to function as:
a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed; and
processing circuitry to
acquire search condition information transmitted from a terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device,
search the control target device identification information, the operation device identification information, and the specific control information stored in the control record storage for at least one of the control target device identification information, the operation device identification information, or the specific control information based on the search condition information, and
generate, when at least one of the control target device identification information, the operation device identification information, or the specific control information is detected, search result information including at least one of the detected control target device identification information, the detected operation device identification information, or the detected specific control information, and transmit the search result information to the terminal, wherein
the control record storage further stores, in a manner associated with the control target device identification information, class information indicating a class of the at least one control target device classified based on a type of the at least one control target device, and
when searching for at least one of the operation device identification information or the control target device identification information based on the search condition and not detecting the operation device identification information or the control target device identification information, the processing circuitry searches for at least one of operation device identification information of an operation device or control target device identification information of a control target device in a same class as at least one of the operation device being a search target or the control target device being a search target.

12. An operation device management system, comprising:
a terminal; and
a control device, wherein
the control device includes
a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed, and
first processing circuitry to
acquire search condition information transmitted from the terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device,
search the control target device identification information, the operation device identification information, and the specific control information stored in the control record storage for at least one of the control target device identification information, the operation device identification information, or the specific control information based on the search condition information, and
generate, when at least one of the control target device identification information, the operation device identification information, or the specific control information is detected, search result information including at least one of the detected control target device identification information, the detected operation device identification information, or the detected specific control information, and transmit the search result information to the terminal, and
when the control target device identification information or the operation device identification information is not detected, the first processing circuitry generates search result information including uniform resource locator information indicating an uniform resource locator of a website showing a list of control target device identification information of a control target device recommended by a manufacturer of the operation device operated by the user or an uniform resource locator of a website showing a list of operation device identification information recommended by a manufacturer of the control target device operated by the user, and transmits the search result information to the terminal.

13. An operation device management apparatus, comprising:
a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed; and
processing circuitry to
acquire search condition information transmitted from a terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device,
search the control target device identification information, the operation device identification information, and the specific control information stored in the control record storage for at least one of the control target device identification information, the operation device identification information, or the specific control information based on the search condition information, and
generate, when at least one of the control target device identification information, the operation device identification information, or the specific control information is detected, search result information including at least one of the detected control target device identification information, the detected operation device identification information, or the detected specific control information, and transmit the search result information to the terminal, wherein
when the control target device identification information or the operation device identification information is not detected, the processing circuitry generates search result information including uniform resource locator information indicating an uniform resource locator of a website showing a list of control target device identification information of a control target device recommended by a manufacturer of the operation device operated by the user or an information recommended by a manufacturer of the control target device operated by the user, and transmits the search result information to the terminal.

14. An operation device management method, comprising:
causing, by a control device, a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed;
acquiring, by the control device, search condition information transmitted from a terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device;
searching, by the control device, the control target device identification information, the operation device identification information, and the specific control information stored in the control record storage for at least one of the control target device identification information, the operation device identification information, or the specific control information based on the search condition information;
generating, by the control device, when at least one of the control target device identification information, the operation device identification information, or the specific control information is detected, search result information including at least one of the detected control target device identification information, the detected operation device identification information, or the detected specific control information, and transmitting the search result information to the terminal; and
generating, by the control device, when the control target device identification information or the operation device identification information is not detected, search result information including uniform resource locator information indicating an uniform resource locator of a website showing a list of control target device identification information of a control target device recommended by a manufacturer of the operation device operated by the user or an uniform resource locator of a website showing a list of operation device identification information recommended by a manufacturer of the control target device operated by the user, and transmitting, by the control device, the search result information to the terminal.

15. A non-transitory recording medium storing a program, the program causing a computer to function as:
a control record storage to store, in a manner associated with one another, specific control information indicating specific control performed on at least one control target device through an operation performed previously on an operation device, operation device identification information identifying the operation device operated, and control target device identification information identifying the at least one control target device on which the specific control has been performed; and
processing circuitry to
acquire search condition information transmitted from a terminal, the search condition information indicating a search condition for searching for at least one of control target device identification information of a control target device controllable with an operation device operated by a user, operation device identification information of an operation device to control a control target device when operated by a user, or specific control information indicating specific control having a record of being performed on the control target device,
search the control target device identification information, the operation device identification information, and the specific control information stored in the control record storage for at least one of the control target device identification information, the operation device identification information, or the specific control information based on the search condition information, and
generate, when at least one of the control target device identification information, the operation device identification information, or the specific control information is detected, search result information including at least one of the detected control target device identification information, the detected operation device identification information, or the detected specific control information, and transmit the search result information to the terminal, wherein
when the control target device identification information or the operation device identification information is not detected, the processing circuitry generates search result information including uniform resource locator information indicating an uniform resource locator of a website showing a list of control target device identification information of a control target device recommended by a manufacturer of the operation device operated by the user or an information recommended by a manufacturer of the control target device operated by the user, and transmits the search result information to the terminal.
